(19) United States
(12) Patent Application Publication
(10) Pub. No.: US 2013/0258552 A1
(43) Pub. Date: Oct. 3, 2013

(54) POROUS GRAPHENE FILM REPRESENTING EXCELLENT ELECTRICAL PROPERTIES AND METHOD OF MANUFACTURING THE SAME

(71) Applicants: Bong-Gill Choi, Daejeon (KR); Yun-Suk Huh, Daejeon (KR)

(72) Inventors: Bong-Gill Choi, Daejeon (KR); Yun-Suk Huh, Daejeon (KR)

(21) Appl. No.: 13/472,168

(22) Filed: May 15, 2012

(30) Foreign Application Priority Data
Apr. 2, 2012 (KR) 10-2012-0034127

(51) Int. Cl. H01G 9/155; B05D 5/00; C01B 31/00; B05D 3/02; B82Y 99/00; B82Y 30/00; B82Y 40/00

(52) U.S. Cl. 361/502; 423/448; 427/243; 977/734; 977/890; 977/948

(57) ABSTRACT

Disclosed is a method of manufacturing a porous graphene film representing superior electrical properties. The method includes preparing a graphene/polymer composite dispersed solution by adding polymer particles to a first graphene dispersed solution obtained by dispersing graphene powders into a solvent, manufacturing a graphene/polymer composite film by using the graphene/polymer composite dispersed solution, and manufacturing the porous graphene film by removing the polymer particles from the graphene/polymer composite film.

This application claims the benefit under 35 U.S.C. §119 of Korean Patent Application No. 10-2012-0034127 filed on Apr. 2, 2012 in the Korean Intellectual Property Office, the entirety of which disclosure is incorporated herein by reference.

### BACKGROUND OF THE INVENTION

1. Field of the Invention

The present invention relates to a technology of manufacturing a graphene film. In more particular, the present invention relates to a porous graphene film capable of representing excellent electrical properties by forming porous holes having various sizes in the graphene film through processes of adding and removing polymer particles during the manufacturing process of the graphene film, and a method of manufacturing the same.

2. Description of the Related Art

As the demands for information communication appliances are rapidly increased according to the advance of digital technologies, and a renewable-energy system is required, the development of next generation systems for storing energy representing high concentration and high power has been required.

Recently, in order to meet the demands, lithium ion batteries and electrochemical capacitors have been developed as the next generation systems for storing energy. In particular, different from a battery based on chemical reaction, a supercapacitor represents rapid charge/discharge, high charge/discharge efficiency, high power, and a semi-permanent cycle life due to ion movement to the interface between an electrode and an electrolyte or due to the charge phenomenon based on surface chemical reaction.

The supercapacitor may be classified into an electric double layer capacitor and a pseudocapacitor according to the mechanism to store energy. The electric double layer capacitor mainly employs activated carbon electrode material and stores energy by separating charges from each other due to electrostatic attraction force on the electric double layer. Meanwhile, the pseudocapacitor is a system to store charges through Faradaic redox reaction occurring on the interfacial surface between an electrode and an electrolyte by using conductive polymer and metal-oxide electrode material.

According to the charge storage principle of the supercapacitor, the supercapacitor represents energy density lower than that of a battery of storing charges through the absorption/desorption of lithium ions.

The energy density E of the supercapacitor is determined by specific capacitance (C) of electrode material and a charge/discharge potential range (V) of the battery as shown in Equation 1.

E=1/2CV² Equation 1

In order to develop a high-concentration and high-power battery, electrode material having high specific capacitance and an electrolyte having a potential window must have developed.

As the related art, there is provided a porous graphene film and a method of manufacturing the same disclosed in Korean Unexamined Patent Publication No. 10-2011-0127363 (published on Nov. 25, 2011).

### SUMMARY OF THE INVENTION

Accordingly, the present invention has been made keeping in mind the above problems occurring in the prior art, and one object of the present invention is to provide a method of manufacturing a porous graphene film, capable of providing porosity to the graphene film by using polymer particles.

Another object of the present invention is to provide a porous graphene film which is manufactured through the above method and has a porous structure.

Still another object of the present invention is to provide an electrochemical device based on the porous graphene film.

In order to accomplish the above objects, according to one aspect of the present invention, there is provided a method of manufacturing a porous graphene film. The method includes (a) preparing a graphene/polymer composite dispersed solution by adding polymer particles to a first graphene dispersed solution obtained by dispersing graphene powders into a solvent, (b) manufacturing a graphene/polymer composite film by using the graphene/polymer composite dispersed solution, and (c) manufacturing the porous graphene film by removing the polymer particles from the graphene/polymer composite film.

In this case, the method further includes (d) coating transition metal, transition metal compound, or noble metal including at least one of Au, Pt, and Pd on the porous graphene film.

The first graphene dispersed solution is obtained by (a1) preparing a graphene oxide dispersed solution by dispersing graphene oxide in a solvent, (a2) preparing a second graphene dispersed solution by reducing the graphene oxide, which is contained in the graphene oxide dispersed solution, to graphene by using a reducing agent, (a3) yielding the graphene powders by drying the second graphene dispersed solution, and (a4) preparing the first graphene dispersed solution by dispersing the graphene powders into the solvent.

In step (b), the graphene/polymer composite film is manufactured through a vacuum filtration method, a langmuir blodgett method, or a spin coating method.

In step (c), the polymer particles are removed by using at least one of a solvent or heat.

The polymer particles include at least one selected from the group consisting of poly styrene, poly (methyl methacrylate) (PMMA), poly vinyl pyrrolidone, poly dimethylsiloxane (PDMS), and poly vinyl chloride (PVC).

According to another aspect of the present invention, there is provided an electrochemical device including two electrodes and an electrolyte interposed between the two electrodes. One of the two electrodes is manufactured by using the porous graphene film.

In this case, the electrolyte includes an ionic liquid.

The present invention having the above structure has the following effects.

First, according to the method of manufacturing the porous graphene film of the present invention, the graphene film formed therein with porous holes having various sizes of 100 nm to 10 μm can be manufactured by applying a process of inserting and removing polymer. In addition, the porous graphene film can represent a wide specific surface area and an improved charge transfer characteristic, so that the porous graphene film can be utilized as material for a high-power energy storage electrode.

Second, according to the method of manufacturing the porous graphene film of the present invention, various transition metals or noble metals serving as energy sources are coated on the surface of the porous graphene film so that the energy density of the graphene film can be improved. In other words, the problem related to the low capacity of the graphene can be solved by easily depositing the transition metal.

Third, the porous graphene film manufactured according to the manufacturing method of the present invention can represent a wider surface area, a mutually connected porous hole structure, higher electric conductivity, and superior mechanical properties when comparing with the graphene film having a layer structure according to the related art. In particular, in high current density, the porous graphene film according to the present invention represents higher capacity than that of existing carbon material. Accordingly, the porous graphene film according to the present invention can be utilized as electrode material for an energy storage and conversion device having electrochemical reaction, an electrochemical sensor, and a solar cell.

### BRIEF DESCRIPTION OF THE DRAWINGS

FIG. 1 is a flowchart schematically showing a method for preparing porous graphene according to the embodiment of the present invention;

FIG. 2 is a flowchart schematically showing an example in which a graphene dispersed solution is prepared;

FIG. 3 is a schematic view showing an example of removing polymer from a graphene/polymer composite film and depositing transition metal;

FIGS. 4a to 4d illustrate SEM images showing sections of a graphene film according to a comparative example and a graphene film according to the embodiment;

FIGS. 5a and 5b are graphs showing electrochemical properties (cyclic voltammograms, CV) in the graphene film according to the comparative example and the porous graphene film according to the embodiment;

FIGS. 6a and 6b are graphs showing the evaluation results of charge/discharge properties in the graphene film according to the comparative example and the porous graphene film according to the embodiment;

FIG. 7 is a graph showing Nyquist plots for the graphene film according to the comparative example and the porous graphene film according to the embodiment.

### DETAILED DESCRIPTION OF THE INVENTION

The advantages, the features, and schemes of achieving the advantages and features will be apparently comprehended by those skilled in the art based on the embodiments, which are detailed later in detail, together with accompanying drawings. The present invention is not limited to the following embodiments but includes various applications and modifications. The embodiments will make the disclosure of the present invention complete, and allow those skilled in the art to completely comprehend the scope of the present invention.

Hereinafter, a porous graphene film with excellent electrical properties and a method of preparing the same according to a preferred embodiment of the present invention will be described in detail with reference to accompanying drawings.

Graphene has a 2-D structure through sp2 bonding and represents a wide surface area, high electrical conductivity, and excellent physical and chemical properties. Accordingly, researches and studies on graphene have been performed in various fields such as a nanoelectronic device, a nanosensor, and an energy storage device, and an energy conversion device.

However, when preparing electrode material in bulk by using graphene, there is a technical limitation that graphene sheets agglomerate together due to van der Waals force therebetween. In order to solve the problem, graphene sheets are vertically arranged on a metal support, which results in superior electrochemical properties of the graphene sheets. However, the technical limitation still remains in that graphene sheets may not be prepared in bulk, so that the commercialization of the graphene may be difficult.

Therefore, according to the present invention, in order to prepare a 3-D porous graphene film serving as high-density and high-power electrode material, processes of inserting and removing polymer particles are additionally performed during the manufacturing process of the graphene film, thereby proving porosity to graphene.

Hereinafter, a method of preparing porous graphene according to the present invention will be described in detail.

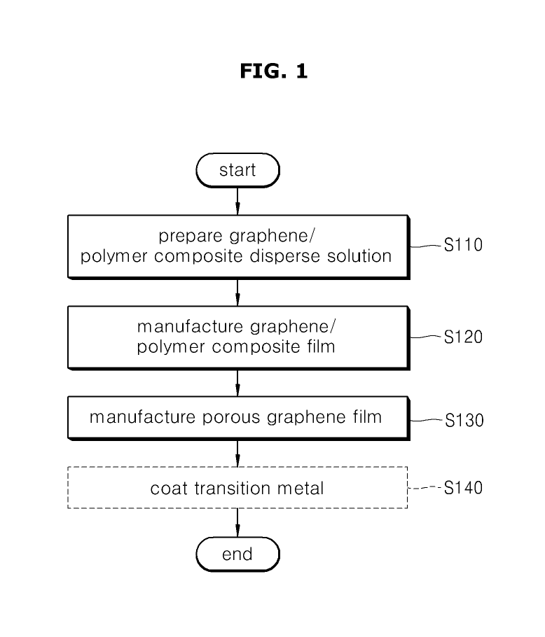

FIG. 1 is a flowchart schematically showing the method of preparing porous graphene according to the embodiment of the present invention.

Referring to FIG. 1, the method of preparing porous graphene includes a step of preparing a graphene/polymer composite disperse solution (step S110), a step of manufacturing a graphene/polymer composite film (step S120), and a step of manufacturing a porous graphene film (step S130).

First, according to the step of preparing the graphene/polymer composite dispersed solution (step S110), polymer particles are put into a graphene dispersed solution in which graphene powders are dispersed in a solvent such as water, thereby preparing the graphene/polymer composite dispersed solution.

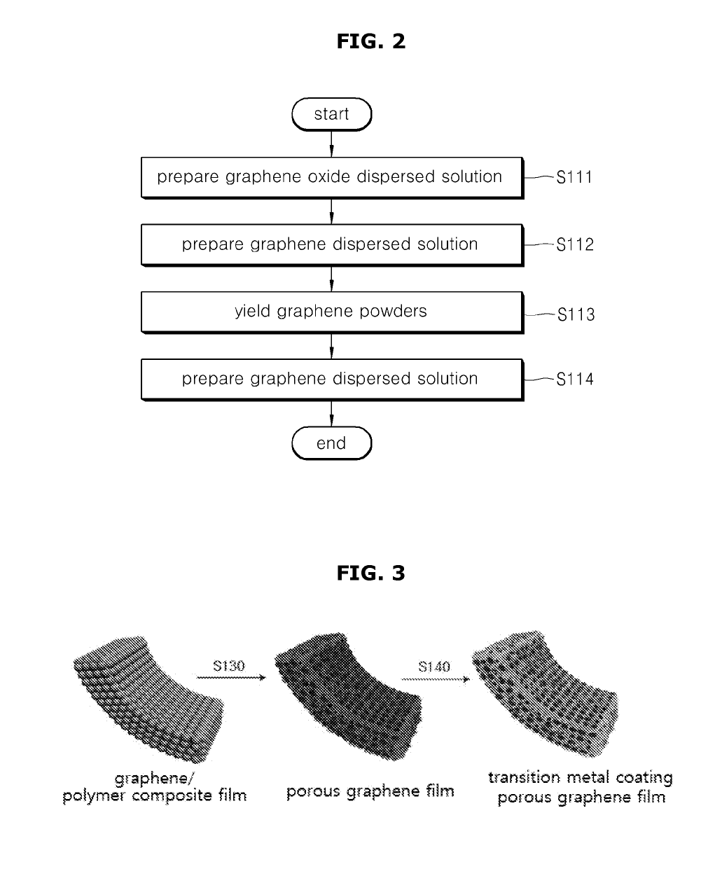

The graphene dispersed solution may be prepared through a preparation process shown in FIG. 2.

Referring to FIG. 2, the graphene dispersed solution can be prepared through the preparation process including a step of preparing a graphene oxide dispersed solution (step S111), a step of preparing the graphene dispersed solution (step S112), a step of yielding graphene powders (step S113), and a step of preparing a graphene dispersed solution (step S114).

In the step of preparing the graphene oxide dispersed solution (step S111), graphene oxide is dispersed into a solvent such as water so that the graphene oxide dispersed solution can be prepared. In detail, 0.01 weight % to 0.1 weight % of the graphene oxide may be added with respect to 100 weight % of the solvent, but the present invention is not limted thereto. In addition, ultrasonic wave treatment may be performed in order to improve the dispersion characteristic of the graphene oxide.

Next, in the step of preparing the graphene dispersed solution (step S112), a reducing agent is input into the graphene oxide dispersed solution to reduce the graphene oxide to graphene. The reducing agent may include a solution containing hydrazine, for example, a hydrazine hydrate solution, or an ammonia solution. An amount of input reducing agent may be about 5 μl to 10 μl with respect to 1 μl of the graphene oxide dispersed solution, but the present invention is not limited thereto.

Thereafter, in the step of yielding the graphene powders (step S113), the graphene powders are yielded by drying the graphene dispersed solution at the temperature of about 80° C. In this case, a step of cleaning the graphene dispersed solution by using distilled water and ethanol may be further performed. In addition, after the graphene dispersed solution has been dried, the cleaning process and another drying process may be additionally performed.

Subsequently, in the step of preparing the graphene dispersed solution (step S114), the graphene powders are dispersed into the solvent such as water so that the high-purity graphene dispersed solution can be prepared. In this case, when the graphene powders are dispersed, the ultrasonic wave treatment may be performed in order to improve the dispersion efficiency.

The graphene dispersed solution can be prepared through the above steps.

Meanwhile, various polymer particles sufficient to occupy predetermined positions in the graphene/polymer composite film and to be removed by a solvent or heat can be added in the present step (step S110). For example, the polymer particles include at least one of poly styrene, poly(methyl methacrylate) (PMMA), poly vinyl pyrrolidone, poly dimethylsiloxane (PDMS), and poly vinyl chloride (PVC).

In addition, the polymer particles are used to form various porous holes at places, in which the polymer particles have been positioned, by removing the polymer particles from the graphene/polymer composite film. To this end, the polymer particles may have a diameter of about 100 nm to about 10 μm. The sizes of porous holes in the graphene film may be determined depending on the diameters of the polymer particles.

Next, according to the step of manufacturing the graphene/polymer composite film (step S120), the graphene/polymer composite film is manufactured from the graphene/polymer composite dispersed solution.

The graphene/polymer composite film may be manufactured through a vacuum filtration method, a langmuir blodgett method, or a spin coating method.

For example, according to the vacuum filtration method, the graphene/polymer composite dispersed solution is filtrated through a filtration film having porous holes of about 0.1 μm to about 0.5 μm, thereby forming a graphene/polymer composite layer on the filtration film. Thereafter, after drying the results of the filtration, the filtration film is separated to form the graphene/polymer composite film.

Subsequently, in the step of manufacturing the porous graphene film (step S130), the porous graphene film is manufactured by removing the polymer particles from the graphene/polymer composite film.

The polymer particles may be removed by selectively dissolving the polymer particles using a solvent. In addition, the polymer particles may be removed by using heat. For example, the polymer particles may be removed by heat at a thermal decomposition temperature of the polymer particles or more. If the polymer particles include polystyrene, heat treatment is performed at a temperature of about 200° C. to about 350° C., so that the polymer particles can be removed from the graphene/polymer composite film.

The polymer particles are removed to form porous holes at places in which the polymer particles have occupied in the graphene/polymer composite film, so that porosity can be provided to the graphene film.

Although polymer has been described as one example, material, such as sphere SiO₂, representing a melting point lower than that of the polymer may be used. In this case, to remove material representing a lower melting point from the graphene/lower-melting-point material composite film, the graphene/lower-melting-point material composite is heated at the temperature exceeding the melting point of the lower-melting-point material.

After the porous graphene film has been formed, in order to enhance the capacitance of the graphene film, a step of coating transition metal, transition metal compound such as MnO₂, and noble metal including at least one of Au, Pt, and Pd may be additionally performed (step S140). The metal may be coated through various methods such as a solution coating and drying method and a deposition method.

FIG. 3 is a schematic view showing one example of removing polymer from the graphene/polymer composite film and depositing transition metal.

Referring to FIG. 3, the porous graphene film may be manufactured through the step of removing the polymer particles from the graphene/polymer composite film (step S130). In addition, the porous graphene film having enhanced capacitance can be manufactured through the step of coating transition metal or transition metal compound on the surface of the porous graphene film (step S140).

The porous graphene film formed through the method according to the present invention can be utilized as an electrode material of an electrochemical device such as a supercapacitor.

The electrochemical device includes two electrodes (anode and cathode) and an electrolyte interposed therebetween. In this case, one of the two electrodes may be manufactured through the method according to the present invention. In other words, one (e.g., cathode) of the two electrodes may include a porous graphene film.

Meanwhile, the electrolyte preferably includes an ionic liquid. The ionic liquid may include 1-ethyl-3-methylimidazolium bis(trifluoromethylsulfonyl)amide.

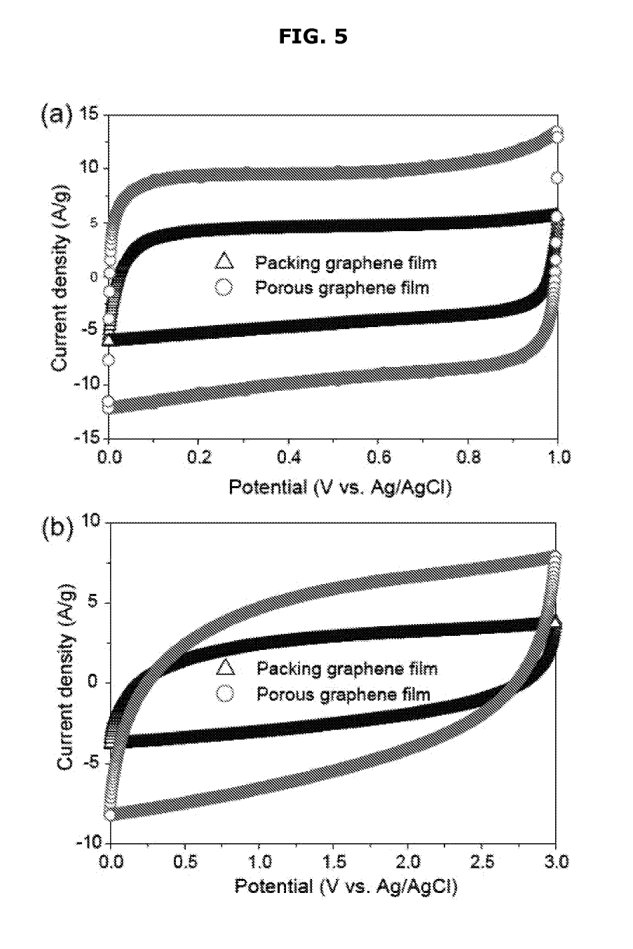

As shown in FIG. 5, when the porous graphene film formed through the method according to the present invention is used as an electrode, and the ionic liquid is used as the electrolyte, the specific capacitance is increased.

### Embodiment

Hereinafter, the structure and the operation of the present invention will be described in more detail with respect to exemplary embodiments of the present invention. However, the exemplary embodiments are provided for the illustrative purpose, and the present invention is not limited thereto.

Since other structures and operations of the present invention can be sufficiently understood by those skilled in the art, the details thereof will be omitted.

1. Manufacturing of Porous Graphene Film

### Embodiment

First, graphene oxide was prepared through a Hummers' scheme. Next, after the graphene oxide was subject to ultrasonic treatment for one hour, 0.05 weight % of the graphene oxide was dispersed into 100 weight % of water, so that a graphene oxide dispersed solution was prepared. Next, 35 μl of hydrazine monohydrate was put into 5 μl of the graphene oxide dispersed solution and stirred at the temperature of 95° C. for one hour, so that the graphene oxide was reduced to graphene. After cleaning the result of the reduction by using distilled water and ethanol, the result was dried at the temperature of 80° C. so that graphene powders were obtained. Thereafter, the graphene powders were subject to ultrasonic treatment and dispersed into the water, so that the graphene dispersed solution was prepared.

Thereafter, polystyrene particles were added into the graphene dispersed solution and stirred for five hours to prepare the graphene/polystyrene composite dispersed solution. Then, the graphene/polystyrene composite dispersed solution was subject to vacuum filtration by using an anodisc membrane (having a 47 mm diameter and 0.2 μm pore size, and produced by Whatman Ltd.), so that the graphene/polymer composite layer was formed on the anodisc membrane. Then, after drying the result at a room temperature, the anodisc membrane was separated from the result so that the graphene/polymer composite film was manufactured.

The polystyrene particles were completely removed from the graphene/polymer composite film by dipping the graphene/polymer composite film into a toluene solution for 24 hours, thereby manufacturing the porous graphene film.

### COMPARATIVE EXAMPLE

The graphene film according to the comparative example was manufactured through the same method as that of the present invention except that processes of adding and removing polystyrene particles were omitted.

2. Observation of Micro-Structure of Graphene Film

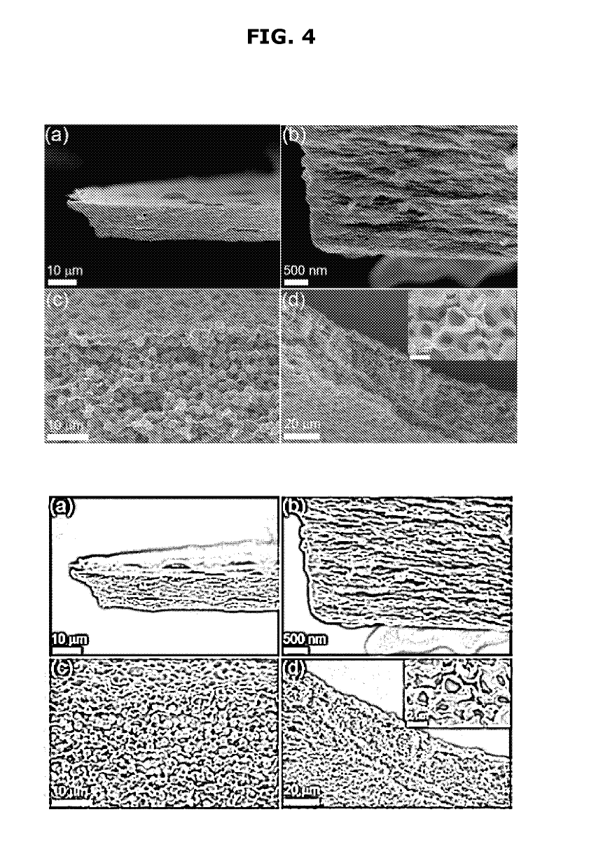

FIGS. 4a and 4b illustrate SEM images showing the sectional surface of the graphene film according to the comparative example.

Since the graphene film according to the comparative film can be provided in the self-supporting form, graphene films can be applied for electrode materials in bulk. However, the grapheme sheet agglomeration may not be avoided when the graphene sheets are self-assembled.

In other words, referring to FIGS. 4a and 4b, in the graphene film according to the comparative example, the restacking of the graphene may be observed. The restacking of the graphene is a main cause in which the transfer rate of ions is reduced to degrade the performance of the supercapacitance.

However, as described according to the embodiment, if polystyrene particles are added during the vacuum filtration process of the graphene to manufacture the composite film and the polystyrene particles are removed, a graphene film having porosity can be manufactured.

FIG. 4c illustrates an SEM image showing the sectional surface of the graphene/polystyrene composite film, and FIG. 4d illustrates an SEM image showing the sectional surface of the porous graphene film without the polystyrene particles.

Referring to FIG. 4c, graphene sheets surrounds the polystyrene particles. This phenomenon is caused due to the strong bonding between the graphene sheets and the polystyrene particles by hydrophobic attraction.

In addition, referring to FIG. 4d, after removing the polystyrene particles, porous holes having sizes corresponding to the sizes of the polystyrene particles were formed in the graphene film.

Meanwhile, even though the polystyrene particles have been removed, the porous hole structure of the graphene is not collapsed because the porous hole structure is coupled with the multi-layered graphene layer surrounding the porous holes.

3. Evaluation of Electrochemical Characteristic of Graphene Film

The electrochemical properties of the graphene films according to the embodiment and the comparative example were measured by using a 3-phase electrode system. The electrochemical properties were measured in a 1M sodium sulfate solution by employing the graphene films according to the embodiment and the comparative example as a working electrode, a platinum wire as a counter electrode, and Ag/AgCl as a reference electrode.

(1) Evaluation of Current Density and Specific Capacitance

FIGS. 5a and 5b are graphs showing electrochemical properties (cyclic voltammogram, CV) according to the types of an electrolyte in the graphene film according to the comparative example and the porous graphene film according to the embodiment. FIG. 5a is a graph showing the electrochemical properties of the graphene films when a 1M sodium sulfate solution is used as an electrolyte, and FIG. 5b is a graph showing the electrochemical properties of the graphene films when an ionic solution is used as the electrolyte.

Referring to FIGS. 5a and 5b, both of a packing graphene film according to the comparative example and a porous graphene film according to the embodiment represent stable CVs, which ranges from 0.0V to 1.0V (see FIG. 5a) in the 1M sodium sulfate solution and ranges from 0.0V to 3.0V (see FIG. 5b) in the ionic liquid, without the electrochemical decomposition of the electrolyte with respect to the reference electrode. The rectangular curves for the CVs of the graphene films represent the behavior of an electric double-layer capacitor.

Meanwhile, in the case of the porous graphene film according to the embodiment, the current density was relatively increased. The quantity (Q) of charges is obtained based on the curve, and specific capacitance (F/g) was found from the measured potential range V and the weight (m) of the electrode material.

$$C ( \frac{F}{g} ) = \frac{Q}{Δ V \times m} \qquad Equation 2$$

In the case of the electrolyte of the 1M sodium sulfate solution, the graphene film according to the comparative example and the porous graphene film according to the embodiment represent specific capacitances of 85.5 F/g and 191.4 F/g, respectively. In the case of the electrolyte of the ionic liquid, the graphene film according to the comparative example and the porous graphene film according to the embodiment represent specific capacitances of 138.9 F/g and 284.5 F/g, respectively. In other words, the porous graphene film according to the embodiment represents specific capacitance twice greater than that of the graphene film according to the comparative example.

The mobility of ions could be improved in the porous graphene film having many porous holes to enhance the performance of a capacitor. The specific capacitance obtained in the electrolyte of the ionic liquid representing a wide potential range was greater than the specific capacitance obtained in the electrolyte of the sodium sulfate solution.

(2) Evaluation of Charge/Discharge Properties

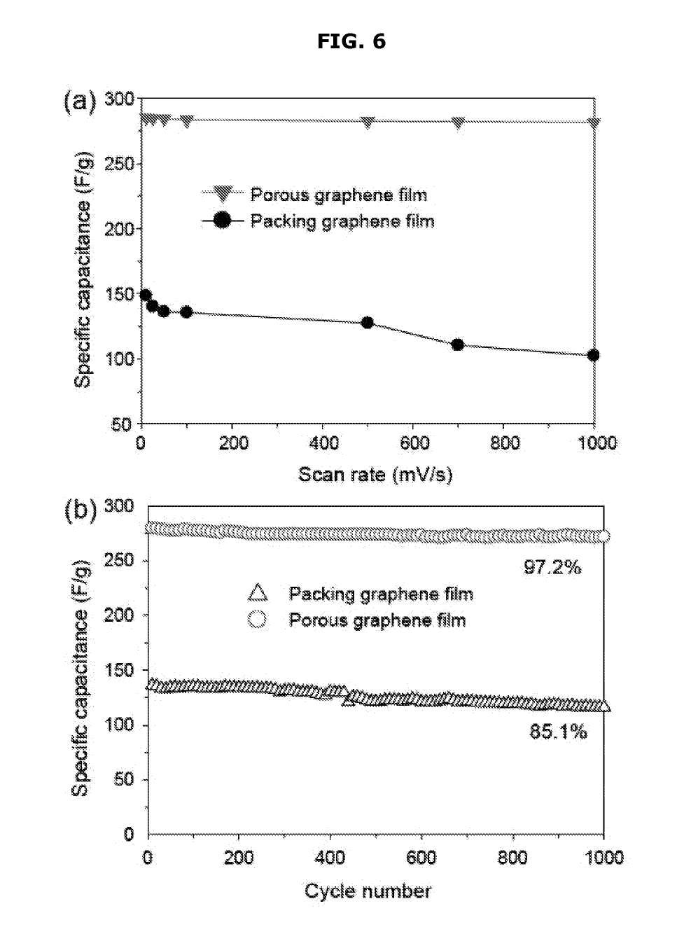

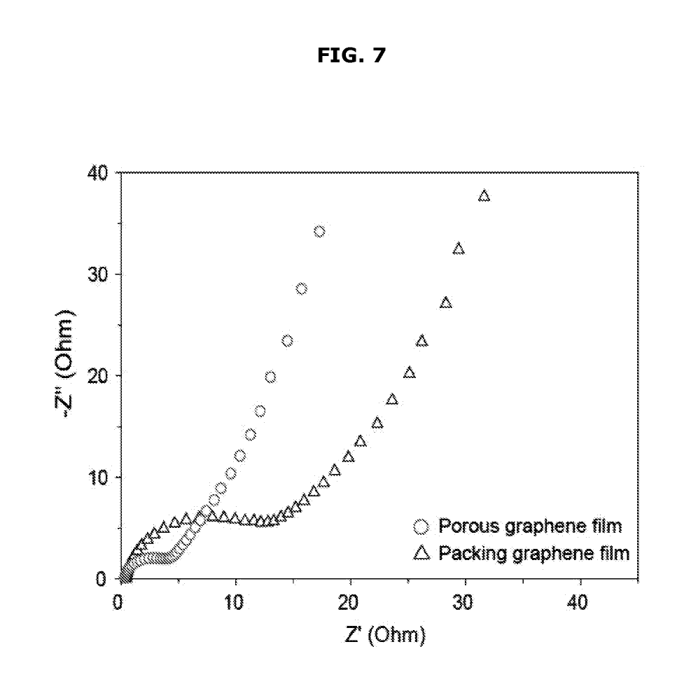

The charge/discharge speed and the charge/discharge cycle life are important indexes used to determine the performance of supercapacitor. In order to observe the charge/discharge properties, specific capacitance was measured at various cyclic voltammetry rates, and the measured result was shown in FIG. 6a. In addition, the charge/discharge tests are performed during 100 cycles at a constant scan rate, and the result was shown in FIG. 6b.

Referring to FIG. 6a, in the case of the packing graphene film according to the comparative example, as the scan rate was increased (from 10 mV/s to 1000 mV/s), the specific capacitance was reduced by 31% of an initial specific capacitance value (which is 148.6 F/g). Meanwhile, in the case of the porous graphene film according to the embodiment, the specific capacitance was reduced only by 1.3% of the initial specific capacitance value. In other words, the charge/discharge speed was more improved in the porous graphene film. This is because ions of the electrolyte are rapidly transferred into porous holes at the above cyclic voltammetry rate, so that charges are rapidly stored on the graphene surface.

In addition, referring to FIG. 6b, the porous graphene film according to the embodiment represents substantially constant specific capacitance during 1000 cycles. The reduction of the specific capacitance by 1.8% is less than the reduction of the specific capacitance by 14.9% in the graphene film according to the comparative example. The stability of the charge/discharge cycle life is more improved in the porous graphene film according to the embodiment.

Accordingly, the charge/discharge speed and the charge/discharge cycle life are improved in the porous graphene film according to the embodiment because the movement speed of electrolytic ions in the porous graphene film according to the embodiment is more improved as compared with the movement speed of the electrolytic ions in the graphene film according to the comparative film.

(3) Evaluation of Impedance Characteristic

FIG. 7 is a graph showing Nyquist plots for the graphene film according to the comparative example and the porous graphene film according to the embodiment in the frequency range of 0.01 Hz to 100 kHz. In this case, an AC impedance measuring device (Solartron 12860W) was used.

Electrolyte resistance (Rs), charge-transfer resistance (RCT), and Warburg impedance were calculated through a fitting program.

In particular, the RCT values of the packing graphene film and the porous graphene film were calculated as 11.7Ω and 3.9Ω, respectively. This means that interfacial resistance of the porous graphene film according to the embodiment is lower than that of the graphene film according to the comparative example.

In addition, the Warburg impedance values of the porous graphene film according to the embodiment were arranged vertically more than those of the packing graphene film according to the comparative example. This means that the ions of the electrolyte are more rapidly transferred in the porous structure.

Based on the impedance data results, the porous graphene film according to the embodiment is more suitable for a capacitor to store charges.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A method of manufacturing a porous graphene film, the method comprising:
(a) preparing a graphene/polymer composite dispersed solution by adding polymer particles to a first graphene dispersed solution obtained by dispersing graphene powders into a solvent;
(b) manufacturing a graphene/polymer composite film by using the graphene/polymer composite dispersed solution; and
(c) manufacturing the porous graphene film by removing the polymer particles from the graphene/polymer composite film.

2. The method of claim 1, further comprising:
(d) coating transition metal, transition metal compound, or noble metal including at least one of Au, Pt, and Pd on the porous graphene film.

3. The method of claim 1, wherein the first graphene dispersed solution is obtained by:
(a1) preparing a graphene oxide dispersed solution by dispersing graphene oxide in a solvent;
(a2) preparing a second graphene dispersed solution by reducing the graphene oxide, which is contained in the graphene oxide dispersed solution, to graphene by using a reducing agent;
(a3) yielding the graphene powders by drying the second graphene dispersed solution; and
(a4) preparing the first graphene dispersed solution by dispersing the graphene powders into the solvent.

4. The method of claim 1, wherein, in step (b), the graphene/polymer composite film is manufactured through a vacuum filtration method, a langmuir blodgett method, or a spin coating method.

5. The method of claim 1, wherein, in step (c), the polymer particles are removed by using at least one of a solvent or heat.

6. The method of claim 1, wherein the polymer particles include at least one selected from the group consisting of poly styrene, poly(methyl methacrylate) (PMMA), poly vinyl pyrrolidone, poly dimethylsiloxane (PDMS), and poly vinyl chloride (PVC).

7. A method of manufacturing a porous graphene film, the method comprising:
(a) preparing a graphene/low-melting-point material composite dispersed solution by adding a material (low-melting-point material) having a melting point lower than a melting point of a graphene into a graphene dispersed solution obtained by dispersing graphene powders in a solvent;
(b) manufacturing a graphene/low-melting-point material composite film by using the graphene/low-melting-point material composite dispersed solution; and
(c) manufacturing a porous graphene film by removing the low-melting-point material from the graphene/low-melting-point material composite film.

8. The method of claim 7, wherein the low-melting-point material includes sphere SiO₂.

9. A porous graphene film manufactured according to claim 1 so that the porous graphene film has a porous structure.

10. An electrochemical device including two electrodes and an electrolyte interposed between the two electrodes, wherein one of the two electrodes is manufactured by using the porous graphene film according to claim 9.

11. The electrochemical device of claim 10, wherein the electrolyte includes an ionic liquid.
